(19) United States
(12) Patent Application Publication
(10) Pub. No.: US 2026/0202022 A1
(43) Pub. Date: Jul. 16, 2026

(54) MODULAR, RECESSED LIGHTING SYSTEM

(71) Applicant: Visual Comfort & Co., Houston, TX (US)

(72) Inventors: Richard Kim, Skokie, IL (US); Sean Lavin, Winnetka, IL (US)

(21) Appl. No.: 19/020,757

(22) Filed: Jan. 14, 2025

(51) Int. Cl. F21S 2/00; F21V 21/005; F21V 21/04; F21V 21/30; F21V 23/06; F21Y 103/00; F21Y 115/10

(52) U.S. Cl. CPC F21S 2/005; F21V 21/005; F21V 21/04; F21V 21/30; F21V 23/06; F21Y 2103/00; F21Y 2115/10

(57) ABSTRACT

A modular lighting system adapted to be installed in and illuminate an environment. The lighting system includes a first light fixture including a first canopy assembly adapted to engage a desired surface in the environment, a first light-emitting diode (LED) module, and a second LED module. The first LED module has a first connector assembly configured to mechanically and electrically connect the first LED module to the first light fixture via the first canopy assembly, the second connector assembly is configured to mechanically and electrically connect the second LED module to the first LED module, and the first LED module is interchangeable with a third LED module including a third connector assembly configured to mechanically and electrically connect the third LED module to both the second LED module and the first light fixture via the first canopy assembly.

### FIELD OF DISCLOSURE

The present disclosure generally relates to lighting systems, and more particularly, a modular, recessed lighting system.

### BACKGROUND

Residential buildings, commercial buildings, and industrial buildings are equipped with lighting systems that typically include several light fixtures configured to illuminate certain environments. In many cases, these lighting systems are recessed lighting systems that provide the effect of light shining through a hole in a ceiling or a wall. Recessed lighting systems generally include one or more light fixtures installed in a ceiling or wall recess. These light fixtures typically include various components (e.g., light-emitting diodes) that are fixed in place relative to one another.

### BRIEF DESCRIPTION OF THE DRAWINGS

FIG. 1 is a perspective view of one example of a modular, recessed lighting system constructed in accordance with the principles of the present disclosure and including a plurality of light fixtures and a plurality of light-emitting diode (LED) modules.

FIG. 2 is an exploded view of a first one of the light fixtures shown in FIG. 1.

FIG. 3 is a bottom view of the first light fixture.

FIG. 4 is a perspective view of a second one of the light fixtures shown in FIG. 1.

FIG. 5 is a first exploded view of the second light fixture.

FIG. 6 is a second exploded view of the second light fixture.

FIG. 7A is a perspective view of one of the LED modules, showing first and second connectors for mechanically and electrically connecting the LED module to one or more other LED modules and/or one of the light fixtures.

FIG. 7B is a top, cross-sectional view of the LED module taken along line A-A of FIG. 7A.

FIG. 8 is an exploded view of the LED module of FIG. 7A.

FIG. 9 illustrates a plurality of LED modules coupled to the first light fixture.

FIG. 10 illustrates a plurality of LED modules coupled to the second light fixture.

FIG. 11A is a close-up view showing a first LED module mechanically and electrically connected to a second LED module.

FIG. 11B is a top, cross-sectional view of the connection between the LED modules of FIG. 11A

FIG. 12 illustrates a plurality of LED modules coupled to both the first light fixture and the second light fixture.

FIG. 13 illustrates a plurality of LED modules coupled to both the first light fixture and a third light fixture.

FIG. 14 is a perspective view of a hub connector configured to mechanically connect but electrically isolate a first LED module and a second LED module.

FIG. 15 is a top view of the hub connector of FIG. 14.

FIG. 16 illustrates the hub connector of FIG. 14 mechanically connecting a first LED module and a second LED module.

FIG. 17 is a close-up view of the third light fixture shown in FIG. 13.

FIG. 18 is an exploded view of FIG. 17.

FIG. 19 is another exploded view of FIG. 17.

FIG. 20 is a perspective view of another light fixture of the modular, recessed lighting system of FIG. 1.

FIG. 21 is an exploded view of the light fixture of FIG. 20.

FIG. 22 is a perspective view of another light fixture of the modular, recessed lighting system of FIG. 1.

FIG. 23 is an exploded view of the light fixture of FIG. 22.

FIG. 24 illustrates a plurality of LED modules coupled to the light fixture of FIG. 22.

FIG. 25 is a perspective view of another light fixture of the modular, recessed lighting system of FIG. 1.

FIG. 26 is an exploded view of a portion of the light fixture of FIG. 25.

FIG. 27 illustrates two strings of LED modules coupled to the light fixture of FIG. 25.

### DETAILED DESCRIPTION

The present disclosure is generally directed to a modular, recessed lighting system configured to illuminate an environment. The modular, recessed lighting system includes a plurality of light fixtures that are at least partially recessed within a desired surface (e.g., a ceiling, a floor, a wall) in the environment and can be customized to satisfy different aesthetic and/or illuminative requirements. The light fixtures are also provided with decorative patterns that enhance the architecture of the environment, and a plurality of light-emitting diodes (LEDs) configured to illuminate or highlight these decorative patterns in an aesthetically pleasing manner.

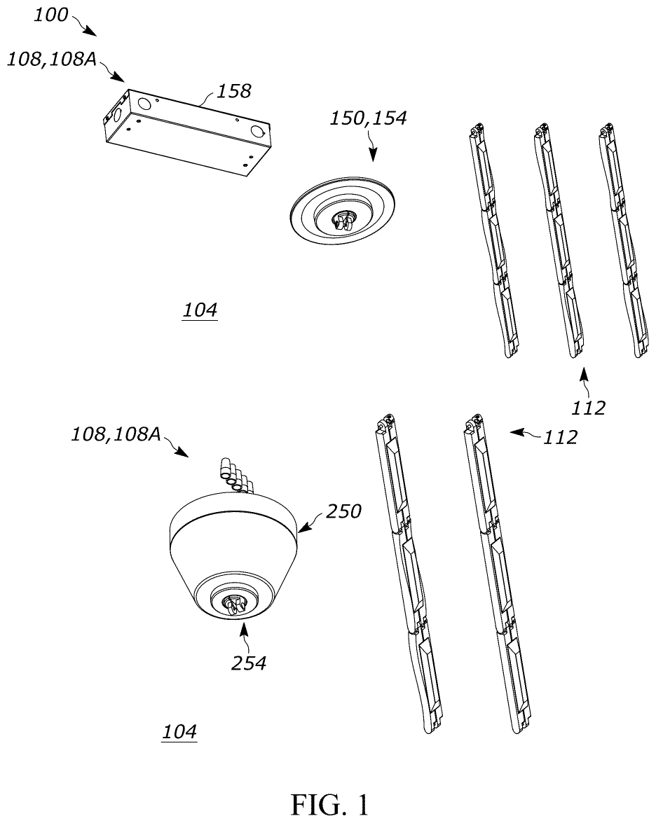

FIGS. 1-11B depict one example of a modular, recessed lighting system 100 constructed in accordance with the principles of the present disclosure and implemented or included in an environment 104, such as, for example, a house, an apartment, a townhouse, a condominium, an office, or other space or building, or portions thereof. In this example, the modular, recessed lighting system 100 is a constant voltage system (e.g., 24 VDC), as will be described in greater detail below. The modular, recessed lighting system 100 generally includes a plurality of light fixtures 108 installed in and configured to illuminate the environment 104 as well as a plurality of LED modules 112 that can be selectively coupled to one another and to any of the plurality of light fixtures 108 in order to customize or adjust the plurality of light fixtures 108 (and, more generally, the recessed lighting system 100) as desired.

In this example, the recessed lighting system 100 includes two light fixtures 108—a first light fixture 108A and a second light fixture 108B that is different from the first light fixture 108A—adapted to be installed in or on a desired surface (e.g., the ceiling, a floor, a wall) in the environment 104. In other examples, the recessed lighting system 100 can include only one light fixture 108 or can include more than two light fixtures 108. For example, the recessed lighting system 100 can include three light fixtures 108—the first light fixture 108A, the second light fixture 108B, and another light fixture (that can be the same as or different than the first light fixture 108A or the second light fixture 108B). In other examples, the recessed lighting system 100 can include various combinations of the different light fixtures and the LED modules 112 described herein.

The first light fixture 108A is generally configured to be installed in or on the desired surface such that a portion of the first light fixture 108A protrudes outward (downward, upward, leftward, or rightward, depending upon the orientation) and into the environment 104. As illustrated in FIGS. 1-3, the first light fixture 108A generally includes a first canopy assembly 150, a first canopy connection assembly 154 removably coupled to the first canopy assembly 150, and a junction box 158 coupled to the first canopy assembly 150. While not illustrated in FIG. 1, it will be appreciated that the junction box 158 includes one or more drivers (e.g., LED drivers) for powering the components of the first light fixture 108A as well as various electrical terminals and wiring for connecting the different components of the first light fixture 108A. While also not illustrated in FIG. 1, it will be appreciated that the first light fixture 108A can optionally also include a heat sink, a controller, one or more diffusers, and/or one or more other components.

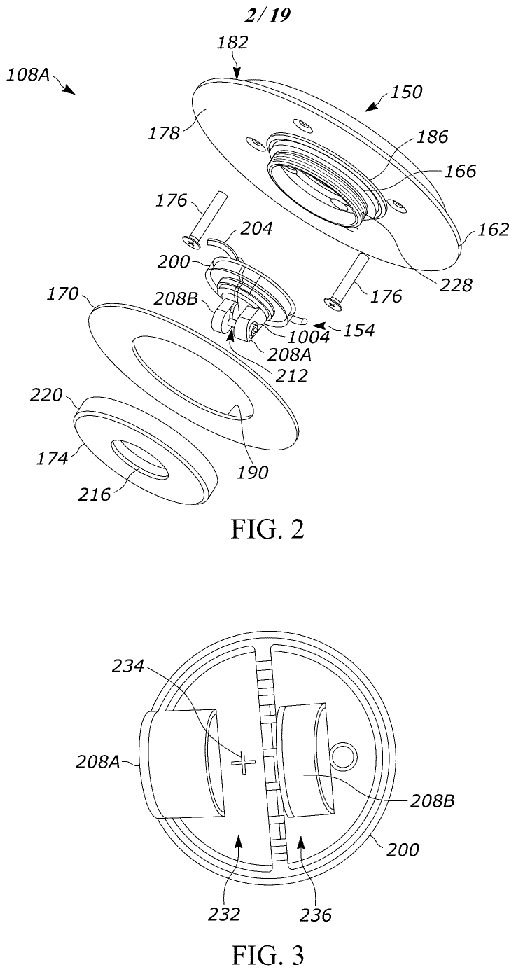

The first canopy assembly 150 is generally configured to be partially disposed in and engage the desired surface (e.g., the ceiling, floor, or other surface) in the environment 104 in order to retain the first light fixture 108A in position in or on the desired surface in the environment 104. In this example, the first canopy assembly 150 includes a canopy plate 162, a collar 166 coupled to the canopy plate 162, and a cover plate 170 (which can be purely decorative) coupled to the canopy plate 162, as best illustrated in FIG. 2. While not explicitly illustrated herein, it will be appreciated that the canopy plate 162 is coupled to the junction box 158 via, for example, a plurality of fasteners 176. The canopy plate 162 has an annular shape and includes a first surface 178 and a second surface 182 opposite the first surface 178. When the first canopy assembly 150 engages the desired surface, the first surface 178 faces away from the desired surface and toward the environment 104, whereas the second surface 182 engages a portion of the desired surface as well as the junction box 158 (not shown). The collar 166, which in this example has an annular shape, has a first portion that is disposed in an opening 186 of the canopy plate 162, and a second portion that is disposed outside of the opening 186, such that the collar 166 extends outward from and of the first surface 178 of the canopy plate 162. Meanwhile, the cover plate 170 in this example also has an annular shape, with an opening 190 that is sized to receive a portion of the collar 166. In turn, the cover plate 170 is configured to be seated against the canopy plate 162 (and more particularly the first surface 178) such that the collar 166 also extends outward from and of the cover plate 170.

The first canopy connection assembly 154 is generally configured to mechanically and electrically connect the first light fixture 108A to any LED modules 112 coupled to the first light fixture 108A (and vice-versa). As best illustrated in FIG. 2, the first canopy connection assembly 154 in this example includes a base 200, electrical wiring 204, and a pair of connectors 208 coupled to the base 200. The base 200 is sized to be disposed within, and be surrounded by, the collar 166. Thus, in this example, the base 200 also has an annular shape. The electrical wiring 204 extends radially outwardly from the base 200 and helps to electrically connect the pair of connectors 208 (and any LED modules 112) to the junction box 158. The pair of connectors 208 extend outward from the base 200, with a first connector 208A extending outward along a first axis and a second connector 208B extending outward along a second axis parallel to the first axis, such that the second connector 208B is spaced from the first connector 208A. In turn, the first canopy connection assembly 154 also includes a recess 212 defined between the first connector 208A and the second connector 208B. As will be discussed in greater detail below, the recess 212 is sized to receive a portion of an LED module 112 directly coupled to the first light fixture 108A in order to mechanically and electrically connect the LED module 112 to the first light fixture 108A (and vice-versa).

With reference still to FIG. 2, the first canopy assembly 150 in this example also includes a ring 174 removably coupled to the collar 166 in order to retain the other components of the first canopy assembly 150 and the components of the first canopy connection assembly 154 in place. In this example, the ring 174 is removably coupled to the collar 166 via a plurality of threads 216 formed on an inner surface of a rim 220 of the ring 174 and configured to threadably engage a plurality of threads (not shown) formed on an outer surface 228 of the second portion of the collar 166. In other examples, however, the ring 174 can be coupled to the collar 166 in a different manner and/or the ring 174 can be coupled to a different component. In any event, when the ring 174 is coupled to the collar 166, the pair of connectors 208 extend outward from and of the ring 174, such that the pair of connectors 208 are arranged to engage one of the LED modules 112 to mechanically and electrically connect the first light fixture 108A to that LED module 112.

Because the system 100 is a constant voltage system, and because the first canopy connection assembly 154 is configured to provide both a mechanical and electrical connection, the first canopy connection assembly 154 has a positive side (with positive polarity) and a negative side (with negative polarity). As illustrated in FIG. 3, the first canopy connection assembly 154 in this example is approximately divided in half, with a first, positive half 232 that is marked with a positive indicator 234, and a second, negative half 236 that is electrically isolated from the first, positive half 232. The first, positive half 232 includes the first connector 208A and the second, negative half 236 includes the second connector 208B. In other examples, however, the first half 232 can have a negative polarity and the second half 236 can have a positive polarity.

Like the first light fixture 108A, the second light fixture 108B is generally configured to be installed in or on the desired surface such that a portion of the second light fixture 108B protrudes outward (downward, upward, leftward, or rightward, depending upon the orientation) and into the environment 104. As illustrated in FIGS. 1 and 4-6, and much like the first light fixture 108A, the second light fixture 108B generally includes a second canopy assembly 250, a second canopy connection assembly 254 removably coupled to the second canopy assembly 250, and, though not shown, a junction box, e.g., the junction box 158, coupled to the second canopy assembly 250. However, unlike the first light fixture 108A, the second light fixture 108B also includes a transformer 258 configured to transfer electrical energy from the junction box to the second canopy connection assembly 254 (and to any LED modules 112 coupled to the second light fixture 108B). While not illustrated in FIGS. 1 and 4-6, it will be appreciated that the second light fixture 108B can optionally also include a heat sink, a controller, one or more diffusers, and/or one or more other components.

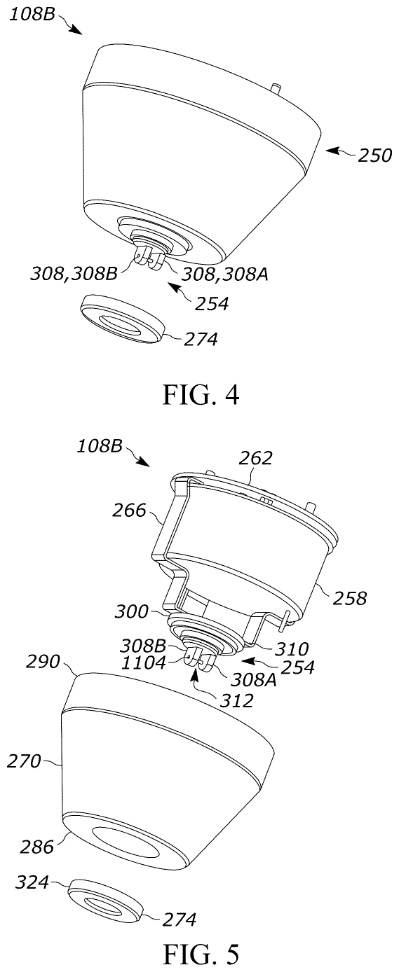

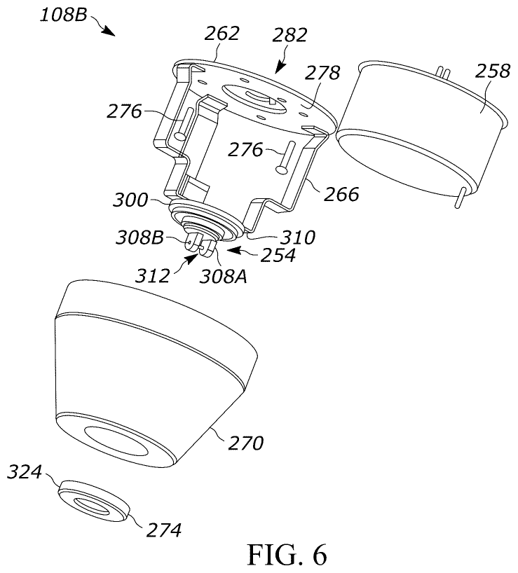

Like the first canopy assembly 150, the second canopy assembly 250 is generally configured to be partially disposed in and engage the desired surface (e.g., the ceiling, floor, or other surface) in the environment 104 in order to retain the second light fixture 108B in position in or on the desired surface in the environment 104. However, the second canopy assembly 250 differs structurally from the first canopy assembly 150. In this example, the second canopy assembly 250 includes a canopy plate 262, a frame 266 coupled to the canopy plate 262, and a canopy housing 270, as best illustrated in FIGS. 5 and 6. While not explicitly illustrated herein, it will be appreciated that the canopy plate 262 is coupled to the junction box via, for example, a plurality of fasteners 276 (shown in FIG. 6). The canopy plate 262 has an annular shape and includes a first surface 278 and a second surface 282 opposite the first surface 278. When the second canopy assembly 250 engages the ceiling (or other desired surface), the first surface 278 faces away from the desired surface and toward the environment 104, whereas the second surface 282 engages a portion of the desired surface as well as the junction box. Meanwhile, the frame 266 is coupled to and extends outward from the first surface 278. The frame 266 is generally sized so as to receive and retain the transformer 258 therein. The canopy housing 270, which can also be referred to as a cover plate, is sized to receive both the canopy plate 262 and the frame 266, such that when the second canopy assembly 250 is installed, neither the canopy plate 262 nor the frame 266 is visible (as illustrated in FIG. 4). In this example, the canopy housing 270 has a frustoconical shape defined by a first end 286 and a second end 290 opposite the first end 286, though other shapes are possible as well.

Like the first canopy connection assembly 154, the second canopy connection assembly 254 is generally configured to mechanically and electrically connect the second light fixture 108B to any LED modules 112 coupled to the second light fixture 108B (and vice-versa). The second canopy connection assembly 254 is also similar structurally to the first canopy connection assembly 154, in that the second canopy connection assembly 254 includes a base 300, electrical wiring (not shown), and a pair of connectors 308 coupled to the base 300, as best illustrated in FIGS. 5 and 6. The base 300 is similar to the base 200, but the base 300 is coupled (in any known manner) to an end 310 of the frame 266 such that the canopy plate 262, the frame 266, and the base 300 (and the pair of connectors 308 coupled thereto) form a unitary structure. While not shown, it will be appreciated that the electrical wiring, meanwhile, electrically connects the transformer 258 with the pair of connectors 308 (and vice-versa). Like the pair of connectors 208, the pair of connectors 308 extend outward from the base 300, with a first connector 308A extending outward along a first axis and a second connector 308B extending outward along a second axis parallel to the first axis, such that the second connector 308B is spaced from the first connector 308A. In turn, the second canopy connection assembly 254 also includes a recess 312 defined between the first connector 308A and the second connector 308B. As will be discussed in greater detail below, the recess 312 is sized to receive a portion of an LED module 112 directly coupled to the second light fixture 108B in order to mechanically and electrically connect the LED module 112 to the second light fixture 108B (and vice-versa).

With continued reference to FIGS. 4-6, the second canopy assembly 250 in this example also includes a ring 274. The ring 274 is similar to, but slightly smaller than, the ring 174, and is removably coupled to the base 300 at the first end 286 of the canopy housing 270 in order to retain the components of the second light fixture 108B in place. In this example, the ring 274 is removably coupled to the base 300 via a plurality of threads (not shown) formed on an inner surface of a rim 324 of the ring 274 and configured to threadably engage a plurality of threads (not shown) formed on an outer surface of the base 300. In other examples, however, the ring 274 can be coupled to the base 300 in a different manner and/or the ring 274 can be coupled to a different component. In any event, when the ring 274 is so coupled to the base 300, the transformer 258, the canopy plate 262, and the frame 266 are disposed within the canopy housing 270, while the pair of connectors 308 extend outward from and of the ring 274. In turn, the pair of connectors 308 are arranged to engage one of the LED modules 112 to mechanically and electrically connect the second light fixture 108B to that LED module 112.

Because the system 100 is a constant voltage system, and because the first canopy connection assembly 254 is configured to provide both a mechanical and electrical connection, the first canopy connection assembly 254 has a positive side (with positive polarity) and a negative side (with negative polarity). While not explicitly illustrated herein, the first canopy connection assembly 254 in this example is approximately divided in half, with a first, positive half that is marked with a positive indicator (e.g., like the positive indicator 234), and a second, negative half electrically isolated from the first, positive half. The first, positive half includes the first connector 308A and the second, negative half includes the second connector 308B. In other examples, however, the first half can have a negative polarity and the second half can have a positive polarity.

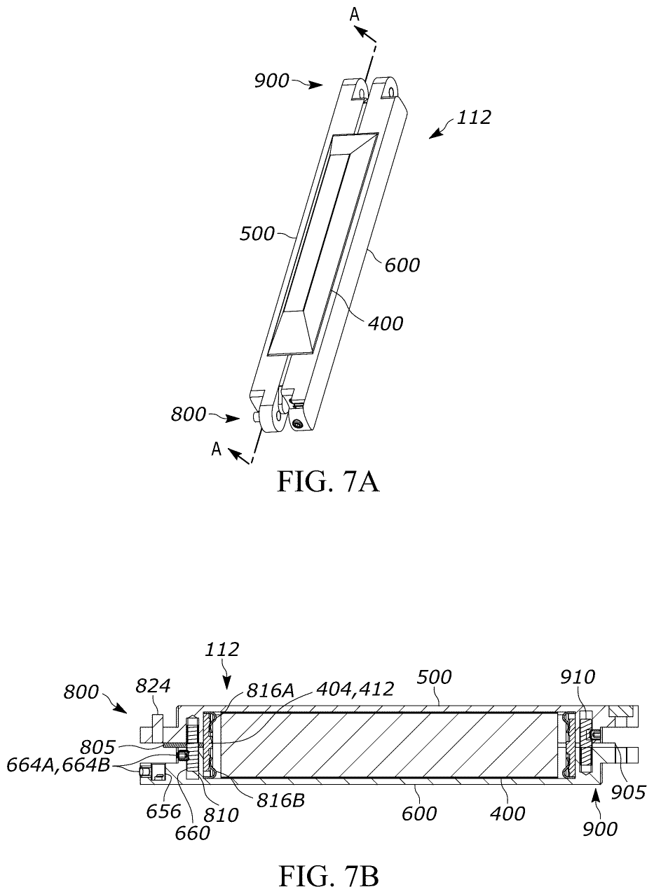

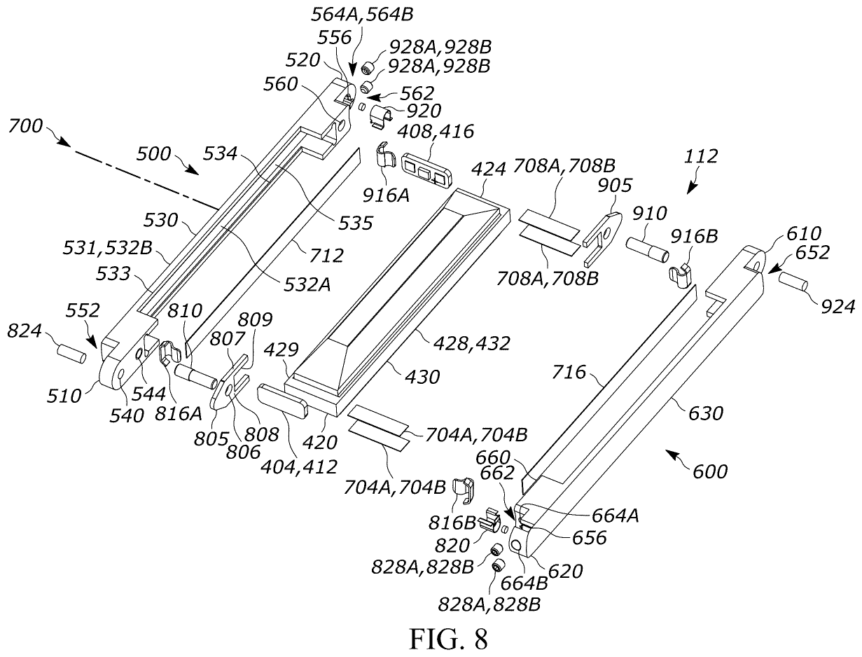

FIGS. 7A, 7B, and 8 illustrate one of the LED modules 112, which at least in this example are identical to one another. As illustrated, in this example, each LED module 112 in the recessed lighting system 100 includes a diffuser 400, a first connector 500, a second connector 600 coupled to and electrically isolated from the first connector 500, a first printed circuit board (PCB) 404, a second PCB 408, one or more first LEDs 412 coupled to the first PCB 404, and one or more second LEDs 416 coupled to the second PCB 408. Each of the one or more first LEDs 412 and the one or more second LEDs 416 is generally configured to emit light to provide illumination to the environment 104 via the diffuser 400. More particularly, in this example, each LED module 112 includes three first LEDs 412 and three second LEDs 416. In other examples, however, one or more of the LED modules 112 can vary from the LED module 112 illustrated in FIGS. 7A, 7B, and 8. As an example, one or more of the LED modules 112 can instead include more or less PCBs (e.g., only a single PCB) and more or less LEDs (e.g., only a single LED).

The diffuser 400 generally serves to provide decorative appeal and to emit the light from the one or more first LEDs 412 and the one or more second LEDs 416. In this example, the diffuser 400 has a rectangular shape and includes a first end 420, a second end 424 opposite the first end 420, a central portion 428 disposed between the first end 420 and the second end 424, a first side 429 disposed adjacent to the first connector 500, and a second side 430 opposite the first side 429. In other examples, however, the diffuser 400 can have a different shape. As an example, the diffuser 400 can instead have a conical, spherical, pyramidal, cylindrical, or cubical shape. Moreover, in this example, the diffuser 400 is completely enclosed and made of a material such as glass (e.g., crystal) that enhances the aesthetic appeal of the respective LED module 112. In other examples, the diffuser 400 can be open at the first end 420 or the second end 424 or include slits in the central portion 428, and can instead be made of one or more different materials (e.g., stainless steel, a natural stone such as Alabaster, or a plastic material such as Acrylic). The diffuser 400 preferably includes a plurality of tapered sections 432 that extend between the first end 420 or the second end 424, the first side 429 or the second side 430, and the central portion 428 and further enhance the aesthetic appeal of the respective LED module 112. In other examples, the diffuser 400 may not include tapered sections 432, may include more or less tapered sections 432, or the tapered section 432 may be a different length or shape than in the present example.

The first connector 500 is removably coupled to the diffuser 400 and intended to electrically connect the LED module 112 to another LED module 112 (or to one of the light fixtures 108) and to retain a portion of the diffuser 400 with the LED module 112. As best illustrated in FIG. 8, the first connector 500 generally includes a first end 510, a second end 520 opposite the first end 510, and a first body 530 disposed between the first end 510 and the second end 520. In this example, the first connector 500 has a rounded, rectangular shape and the first and second ends 510, 520 are rounded. In other examples, the first connector 500 can instead have a conical, spherical, pyramidal, cylindrical, or cubical shape. Moreover, in the present example, the first connector 500 is made of a conductive metal material (e.g., brass). However, in other examples, the first connector 500 can be made of any suitable rigid, conductive material including copper, steel, aluminum, or graphite. In turn, the first connector 500 is configured to direct electricity from the first end 510 of the first connector 500 to the second end 520 of the first connector 500 via the first body 530. In this example, and as will be discussed in greater detail below, the first connector 500 is configured to transfer a positive charge between the first end 510 of the first connector 500 to the second end 520 of the first connector 500 via the first body 530, such that the first connector 500 can transfer the positive charge to other modules 112 connected thereto. In other examples, the first connector may transfer a negative charge. In this example, the first end 510 is disposed adjacent the first end 420 of the diffuser 400, and the second end 520 is disposed adjacent the second end 424 of the diffuser 400.

As illustrated in FIGS. 7B and 8, the first connector 500 in this example further includes a first opening 540 disposed adjacent the first end 510, a second opening 544 disposed between the first opening 540 and the first body 530, a recess 552 partially defined by the first end 510, a third opening 556 disposed adjacent the second end 520, a fourth opening 560 disposed between the third opening 556 and the first body 530, a recess 562 partially defined by the second end 520, and a pair of screw holes 564A, 564B. The first opening 540 is arranged axially parallel to the second opening 544 and generally configured to receive a fastener (e.g., a screw, stud, or the like), as will be discussed in greater detail below. Similarly, the second opening 544 is generally configured to receive a fastener (e.g., a screw, stud, or the like), as will also be discussed in greater detail below. As will be discussed in greater detail below, the recess 552 is sized to receive a portion of one of the light fixtures 108 or a portion of another LED module 112 adjacent thereto, depending on whether the first end 510 is mechanically and electrically connected to one of the light fixtures 108 or to another LED module 112 adjacent thereto.

With reference still to FIG. 8, the third opening 556 is arranged axially parallel to the fourth opening 560 and generally configured to receive a fastener (e.g., a screw, stud, or the like), as will be discussed in greater detail below. Similarly, the fourth opening 560 is generally configured to receive a fastener (e.g., a screw stud, or the like). As will be discussed in greater detail below, the recess 562 is sized to receive a portion of one of the light fixtures 108 or a portion of another LED module 112 adjacent thereto, depending on whether the second end 520 is mechanically and electrically connected to one of the light fixtures 108 or to another LED module 112 adjacent thereto. The pair of screw holes 564A, 564B are arranged adjacent the second end 520 and axially perpendicular to the third opening 556 and the fourth opening 560, respectively.

The first body 530 is generally configured to mechanically and electrically connect the first end 510 and the second end 520, and to retain the diffuser 400. The first body 530 generally includes a base 531, a first flange 533, a second flange 534, and a channel 535. The base 531 has a first surface 532A that faces the diffuser 400 and a second surface 532B that is opposite the first surface 532A and faces away from the diffuser 400. The first flange 533 and the second flange 534 protrude from opposite portions of the base 531 and, along with the first surface 532A, help to form the channel 535. In that way, the first flange 533, the second flange 534, and the channel 535 are generally configured to engage and retain a portion of the diffuser 400, particularly the first side of the diffuser 429, when the first and second connectors 500, 600 and the diffuser 400 are coupled together.

The second connector 600 is substantially similar to the first connector 500. Indeed, the second connector 600 includes a first end 610, a second 620, and a second body 630 that are substantially similar to the first end 510, the second end 520, and the first body 530, respectively. However, the second connector 600 differs from the first connector 500 in multiple respects. First, the second connector 600 is rotated 180 degrees around an axis 700 relative to the first connector 500. Thus, in contrast to the first end 510, the first end 610 is disposed adjacent to the second end 424 of the diffuser 400. Similarly, in contrast to the second end 520, the second end 620 is disposed adjacent to the first end 420 of the diffuser 400. Second, the second connector 600 is configured to transfer an opposite charge than the first connector 500. Thus, in the present example, the second connector 600 transfers negative charge between the first end 610 and the second end 620 such that the second connector 600 can transfer negative charge from the second connector 600 to other LED modules 112 connected thereto. By virtue of this, the first connector 500 and the second connector 600 are coupled to one another. Nonetheless, it is important that the first and second connectors 500, 600 are electrically isolated from one another.

The first PCB 404 and the second PCB 408 are generally configured to support the one or more first LEDs 412 and the one or more second LEDs 416, respectively, in the LED module 112. To this end, the first PCB 404 preferably has an annular shape and is coupled to the first connector 500 and the second connector 600 adjacent to the first end 420 of the diffuser 400, whereas the second PCB 408 preferably has an annular shape and is coupled to the first connector and the second connector 600 adjacent to the second end 424 of the diffuser 400. In this example, the first and second PCBs 404, 408 are disposed at the first and second ends 420, 424 of the diffuser 400, respectively. In other examples, however, the first and second PCBs 404, 408 can be spaced from but immediately adjacent the first and second ends 420, 424 of the diffuser 400, respectively. In turn, at least in this example, the first PCB 404 and the second PCB 408 face one another at opposite ends of the diffuser 400. Moreover, by virtue of this arrangement, the one or more first LEDs 412, which is seated on the first PCB 404, is also positioned at or immediately adjacent the first end 420 of the diffuser 400, and the one or more second LEDs 416, which is seated on the second PCB 408, is also positioned at or immediately adjacent the second end 424 of the diffuser 400. In turn, at least in this example, the one or more first LEDs 412 and the one or more second LEDs 416 face one another at opposite ends of the diffuser 400, with both the one or more first LEDs 412 and the one or more second LEDs 416 configured to emit light into the diffuser 400. In other examples, however, the first PCB 404 and the second PCB 408 (and in turn the one or more first LEDs 412 and the one or more second LEDs 416, respectively) can be positioned elsewhere, against different components (e.g., the first and second connectors, 500, 600, respectively).

The LED module 112 also includes a plurality of different reflectors configured to reflect light from the one or more first LEDs 412 or the one or more second LEDs 416 toward the diffuser 400. As best illustrated by FIG. 8, the LED module 112 in this example includes a first pair of reflectors 704A, 704B, a second pair of reflectors 708A, 708B disposed opposite the first pair of reflectors 704A, 704B, a first reflector 712, and a second reflector 716 disposed opposite the first reflector 716. The first pair of reflectors 704A, 704B are configured to reflect light from the first PCB 404 (and the first LEDs 412 disposed thereon) toward the diffuser 400. To this end, the first pair of reflectors 704A, 704B are disposed adjacent to the first end 420 of the diffuser 400 and removably engaged with an inner surface of the first connector 500 and the second connector 600 near the first end 510 and second end 620, respectively. Meanwhile, the second pair of reflectors 708A, 708B are disposed adjacent to the second end 424 of the diffuser 400. Thus, unlike the first pair of reflectors 704A, 704B, the second pair of reflectors 708A, 708B are removably engaged with an inner surface of the first connector 500 and the second connector 600 adjacent the second end 520 and the first end 610, respectively. In that way, the second pair of reflectors 708A, 708B are configured to reflect light from the second PCB 408 (and the second LEDs 416 disposed thereon) toward the diffuser 400. The first reflector 712 is disposed in the channel 535, engaged with the first surface 532A of the first body 530, and, so positioned, configured to reflect light from either of the first and second LEDs 412, 416. On the other hand, the second reflector 716 is disposed in a channel substantially similar to the channel 535 (but in the second connector 600) and engaged with a first surface (which is substantially similar the first surface 532A) of the second body 630. So positioned, the second reflector 716 is configured to reflect light from either of the first and second LEDs 412, 416.

In the present example, each of the first pair of reflectors 704A, 704B, and each of the second pair of reflectors 708A, 708B, is a substantially rectangular strip (e.g., made of paper) that includes a reflective surface and an adhesive surface opposite the reflective surface for securing the respective reflector 704A, 704B, 708A, 708B in the appropriate position. In other examples, the reflectors 704A, 704B, 708A, 708B may have a different length or width and may have a different shape including, for example, a square, triangle, or oval. Moreover, in other examples, the reflectors 704A, 704B, 708A, 708B may be made of a polymer or ceramic-based material.

In this example, the first reflector 712 and the second reflector 716 are substantially similar to each of the first pair of reflectors 704A, 704B, and the second pair of reflectors 708A, 708B, but differ in multiple ways. First, in the present example, the first reflector 712 and the second reflector 716 are longer than each of the reflectors 704A, 704B, 708A, and 708B. Thus, the first reflector 712 and the second reflector 716 generally (and preferably) have a reflective area greater than that of each of reflectors 704A, 704B, 708A, and 708B, but one of skill in the art will appreciate that the greater reflective area may be achieved by a greater length, a greater width, or a combination of both. Second, the first reflector 712 and the second reflector 716 may have the same reflective surface, or they have may have any other reflective material on the reflective surface. Finally, in the present example, the first and second reflector 712, 716 are generally disposed along a different axis than the reflectors 704A, 704B, 708A, and 708B. Indeed, the reflectors 704A, 704B, 708A, 708B are generally disposed along the traverse axis of the LED module 112 (i.e., parallel to the width of the LED module 112), whereas the first and second reflectors 712, 716 are generally disposed along the longitudinal axis of the LED module 112 (i.e., parallel to the length of the LED module 112).

As best illustrated by FIG. 8, the LED module 112 further includes a first connector assembly 800. The first connector assembly 800 is generally configured to mechanically connect the first end 510 of the first connector 500 to the second end 620 of the second connector 600 while electrically isolating the first connector 500 from the second connector 600 (and vice-versa). The first connector assembly 800 is also configured to mechanically and electrically connect the LED module 112 to an adjacent LED module 112 or one of the light fixtures 108 connected to a first end of the LED module 112 that includes the first end 510 and the second end 620. More particularly, the first connector assembly 800 is also configured to mechanically and electrically connect the first connector 500 to a first portion of the adjacent LED module 112 or one of the light fixtures 108 connected to the first connector 500 via the first end 510 and to mechanically and electrically connect the second connector 600 to a second portion of the adjacent LED module 112 or the light fixture 108 connected to the second connector 600 via the second end 620. To these ends, the first connector assembly 800 generally includes a first insulator bushing 805, a first insulator stud 810, a first pair of contact springs 816A, 816B, a spring clip 820, a first pivot stud 824, and a pair of set screws 828A, 828B.

In the present example, the first insulator bushing 805 is generally rectangular with a rounded end and includes an opening 806, a first surface 807, a second surface 808 opposite the first surface 807, and a slot 809 configured to retain a portion of the diffuser 400. The opening 806 is coaxially aligned with the second opening 544 of the first connector 500 and a fourth opening 660 of the second connector 600 (which is substantially similar to the fourth opening 560). The first surface 807 is removably engaged with the first end 510 of the first connector 500, whereas the second surface 808 is removably engaged with the second end 620 of the second connector 600, such that the first insulator bushing 805 is sandwiched between the first and second connectors 500, 600 (see FIG. 7B). The slot 809 is generally rectangular and disposed adjacent the first end 420 of the diffuser 400, such that the slot 809 is configured to receive and retain the first end 420 of the diffuser 400. In other examples, the first insulator bushing 805 may have a different shape, including, for example, a triangle, square, or circle. Importantly, in the present example, the first insulator bushing 805 is made of a rigid, insulative material (e.g., plastic). Thus, the first insulator bushing 805 is configured to mechanically connect the first and second connectors 500, 600 together while electrically isolating the first connector 500 and the second connector 600.

In the present example, the first insulator stud 810 is generally cylindrical and configured to be arranged in the second opening 544 of the first connector 500, the fourth opening 660 of the second connector 600, and the opening 806 of the first insulator bushing 805. Indeed, the first insulator stud 810 is configured to couple the first connector 500, the second connector 600, and the first insulator bushing 805, and thus retain the diffuser 400, as best illustrated in FIG. 7B. Importantly, like the first insulator bushing 805, the first insulator stud 810 in the present example is made of a rigid insulative material (e.g., plastic). In turn, the first insulator stud 810 is also configured to mechanically connect the first and second connectors 500, 600 while electrically isolating the first connector 500 from the second connector 600 (and vice-versa). Moreover, in other examples, the first insulator stud 810 may have a different shape and may be threaded, hollow, tapered, or have any other variations as are suitable for its intended purpose.

The first pair of contact springs 816A, 816B are generally configured to mechanically and electrically connect the first connector 500 with the positive end of the first PCB 404 and the second connector 600 with the negative end of the first PCB 404, respectively, all while the first connector 500 is electrically isolated from the second connector 600 (due to the first insulator bushing 805 and the first insulator stud 810). In the present example, the first pair of contact springs 816A, 816B removably engage the channel 535 of the first connector 500 and a channel of the second connector 600 that is substantially similar to the channel 533, respectively, to transmit electrical charge to the positive and negatives ends of the first PCB 404. More particularly, the first contact springs 816A, 816B are disposed in the channel 533 and the channel of the second connector 600, respectively, with the first contact spring 816A disposed near at an end adjacent to the first end 510 and the first contact spring 816B disposed near the second end 620. One of skill in the art will appreciate that the first pair of contact springs 816A, 816B are composed of any rigid, conductive material suitable for transmitting electric charge. For example, in the present example, the first pair of contact springs 816A, 816B are made of a spring steel but can instead be made of a different metallic material (e.g., aluminum).

With reference still to FIG. 8, the spring clip 820 is generally configured to electrically and mechanically connect the LED module 112 with the second portion of the adjacent LED module 112 or light fixture 108 connected to the first end of the LED module 112. In this example, the spring clip 820 is removably disposed in the third opening 656 of the second connector 600 and generally has a circular cross-section. Thus, in the present example, the spring clip 820 is configured to electrically and mechanically connect the second connector 600 to the second portion of the adjacent LED module 112 or light fixture 108 connected to the second end 620 of the second connector 600 (via the third opening 656, as will be discussed in greater detail below). In that way, the spring clip 820 transmits electric charge between an end of the second portion of the adjacent LED module 112 or light fixture 108 (connected to the second connector 600) and the second connector 600. Moreover, one of skill in the art will appreciate that the spring clip 820 is made of a rigid, conductive material (e.g., copper) configured for transmitting electricity in the desired manner.

Similarly, the first pivot stud 824 is generally configured to mechanically and electrically connect the LED module 112 (and, more particularly, the first connector 500) with the first portion of the adjacent LED module 112 or light fixture 108 connected to the first end of the LED module 112. In this example, the first pivot stud 824 is removably arranged within the first opening 540 and is configured to be disposed in a suitable opening formed in the first portion of the adjacent LED module 112 or the light fixture 108 connected to the first end of the LED module 112. In particular, the first pivot stud 824 is generally cylindrical and sized to disposed in and engaged with a spring clip of an adjacent LED module 112 (e.g., the spring clip 820) or a connector of one of the light fixtures 108 (e.g., the connector 208A). One of skill in the art will appreciate that the first pivot stud 824 is made of a rigid, conductive material (e.g., stainless steel) such that the first pivot stud 824 is configured for transmitting electricity between the first connector 500 and the LED module 112 or the light fixture 108 connected to the first end 510 as well as through the first connector 500.

The first pair of screws 828A, 828B are generally configured to be disposed in respective holes in the LED module 112 to retain other components in place in the LED module 112. For example, the pair of screws 828A, 828B can be disposed in a pair of screw holes 664A, 664B, respectively, formed in the second end 620 of the second connector 600 to retain fasteners (e.g., a screw, stud, or the like) in the third and fourth openings 656, 660, respectively.

The LED module 112 further includes a second connector assembly 900. The second connector assembly 900 is generally configured to mechanically connect the second end 520 of the first connector 500 to the first end 610 of the second connector 600 while electrically isolating the first connector 500 from the second connector 600 (and vice-versa). The second connector assembly 900 is also configured to mechanically and electrically connect the LED module 112 to an adjacent LED module 112 or one of the light fixtures 108 connected to a second end of the LED module 112 that includes the second end 520 and the first end 610. More particularly, the second connector assembly 900 is also configured to mechanically and electrically connect the first connector 500 to a first portion of the adjacent LED module 112 or light fixture 108 connected to the first connector 500 via the second end 520 and to mechanically and electrically connect the second connector 600 to a second portion of that adjacent LED module 112 or light fixture 108 connected to the second connector 600 via the first end 610. To these ends, the second connector assembly 900 is disposed adjacent to the second end of the LED module 112 (and, more particularly, the second end 424 of the diffuser 400), whereas the first connector assembly 800 is disposed adjacent to the first end of the module 112 (and, more particularly, the first end 420 of the diffuser 400). Otherwise, however, the second connector assembly 900 in the present example is substantially identical to the first connector assembly 800, and includes a second insulator bushing 905, a second insulator stud 910, a second pair of contact springs 916A, 916B, a spring clip 920, a second pivot stud 924, and pair of screws 928A, 928B. These components of the second connector assembly 900 are substantially structurally and functionally identical to these same components of the first connector assembly 800.

As discussed above, the plurality of LED modules 112 can be selectively coupled to one another and to any of the plurality of light fixtures 108 in order to customize or adjust the plurality of light fixtures 108 (and, more generally, the recessed lighting system 100) as desired. Thus, in this example, when the first light fixture 108A and the second light fixture 108B are installed in or on the desired surface in the environment, the plurality of LED modules 112 can be selectively coupled to one another and to either or both of the first light fixture 108A and the second light fixture 108B.

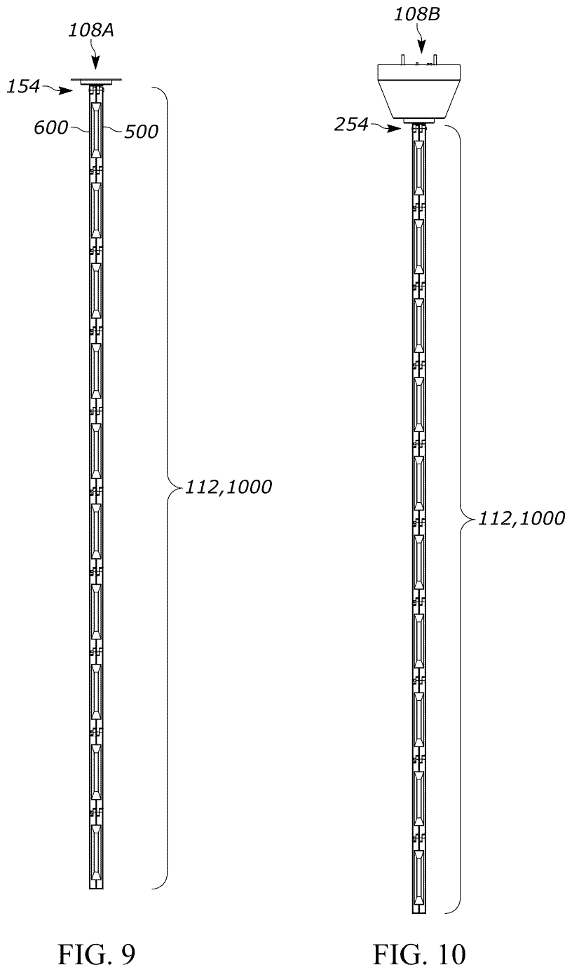

FIG. 9, for example, illustrates thirteen LED modules 112 coupled to the first light fixture 108A and to one another such that the LED modules 112 form a string 1000 of LED modules that hangs from the first light fixture 108A (straight down, at least in this example). FIG. 10, meanwhile, illustrates thirteen LED modules 112 coupled to the second light fixture 108B and to one another such that the LED modules 112 form a string 1100 of LED modules that hangs from the second light fixture 108B (straight down, at least in this example). In other examples, however, the string 1000 or the string 1100 can include a different number of LED modules 112.

In order to mechanically and electrically connect one of the LED modules 112 (the top LED module 112 in FIG. 9) to the first light fixture 108A, the first canopy connection assembly 154 of the first light fixture 108A is directly coupled to the first connector 500 and the second connector 600 of that LED module 112, as best illustrated in FIG. 9. In particular, in the present example, the first light fixture 108A and the respective LED module 112 are positioned so that (i) the positive side of the first canopy connection assembly 154 is aligned (vertically) with the positive first connector 500, and (ii) the negative side of the first canopy connection assembly 154 is aligned (vertically) with the negative second connector 600. Next, the connectors 208A, 208B are disposed in the recess 552 and a recess 662 (which is substantially similar to the recess 562), respectively, and one of the first and second ends 510, 620 of the connectors 500, 600, respectively, is disposed in the recess 212 of the first canopy connection assembly 154. This arrangement causes the other one of the first and second ends 510, 620 of the other of the connectors 500, 600 to be disposed outside of the recess 212 but in engagement with one of the connectors 208A, 208B. In turn, the apertures 1004 of the connectors 208A, 208B and the first opening 540 (which in this example does not include the pivot stud 540) and the third opening 656 of the connectors 500, 600, respectively, are (horizontally) aligned with one another. The connectors 208A, 208B, 500, 600 can be removably secured in this position by inserting one or more fasteners in the apertures 1004 and the first and third openings 540, 656. In this example, the connectors 208A, 208B, 500, 600 can be removably secured in this position by inserting two Allen head screws in the apertures 1004 and the first and third openings 540, 656. In other examples, different fasteners can be used to removably secure the connectors 208A, 208B, 500, 600 in position. In any event, by virtue of this mechanical and electrical connection between the first light fixture 108A and the respective LED module 112, the one or more drivers of the junction box 158 of the first light fixture 108A can provide power to both the first and second LEDs 412, 416 of the respective LED module 112 directly coupled thereto, which in turn emit light, as well as to the first and second LEDs 412, 416 of any LED modules 112 part of the string 1000 of the LED modules that hangs from the first light fixture 108A. In this example, one side of the string 1000 includes one or more first connectors 500 of the one or more LED modules 112 that transmit positive charge through the string 1000, whereas the other side of the 1000 includes one or more second connectors 600 of the one or more LED modules 112 that transmit negative charge through the string 1000.

Likewise, in order to mechanically and electrically connect one of the LED modules 112 (the top LED module 112 in FIG. 10) to the second light fixture 108B, the second canopy connection assembly 254 of the second light fixture 108B is directly coupled to the connector 500 and the connector 600, as illustrated in FIG. 10. In particular, in the present example, the second light fixture 108B and the respective LED module 112 are positioned so that (i) the positive side of the second canopy connection assembly 254 is aligned (vertically) with the positive first connector 500, and (ii) the negative side of the second canopy connection assembly 254 is aligned (vertically) with the negative second connector 600. Next, the connectors 208A, 208B are disposed in the recess 552 and the recess 662, respectively, and one of the first and second ends 510, 620 of the connectors 500, 600, respectively, is disposed in the recess 312 of the second canopy connection assembly 254. This arrangement causes the other one of the first and second ends 510, 620 of the connectors 500, 600 to be disposed outside of the recess 312 but in engagement with one of the connectors 208A, 208B. In turn, the apertures 1004 of the connectors 208A, 208B and the first and third openings 540, 656 of the connectors 500, 600 are (horizontally) aligned with one another. The connectors 208A, 208B, 500, 600 can be removably secured in this position by inserting one or more fasteners in the apertures 1004 and the first and third openings 540, 656. In this example, the connectors 208A, 208B, 500, 600 can be removably secured in this position by inserting two Allen head screws in the apertures 1004 and the first and third openings 540, 656. In other examples, different fasteners can be used to removably secure the connectors 208A, 208B, 500, 600 in position. In any event, by virtue of this mechanical and electrical connection between the second light fixture 108B and the respective LED module 112, the one or more drivers of the junction box 158 of the second light fixture 108B can provide power to both the first and one or more second LEDs 412, 416 of the respective LED module 112 directly coupled thereto, which in turn emit light, as well as to the first and second LEDs 412, 416 of any LED modules 112 part of the string 1000 of the LED modules that hangs from the second light fixture 108B. In this way, one side of the string 1000 includes one or more first connectors 500 of the one or more LED modules 112 that transmit positive charge through the string 1000. Thus, the other side of the 1000 includes one or more second connectors 600 of the one or more LED modules 112 that transmit negative charge through the string 1000.

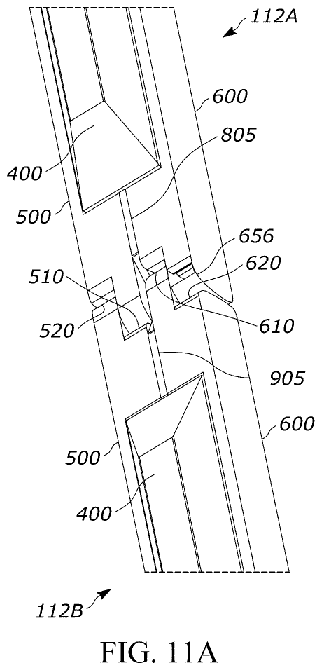

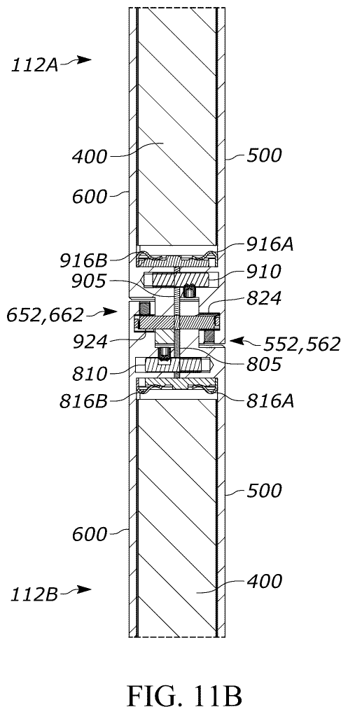

This process of mechanically and electrically connecting LED modules 112 together can be repeated any number of times as needed to form the string 1000, the string 1100, or a different string, though generally each string should be limited to a length of 20 feet (e.g., 47 LED modules 112 or 80 modules 112) due to weight and electrical limitations (longer strings will need to be powered at two ceiling points as discussed below). In turn, the power provided by the one or more drivers of the first light fixture 108A or the second light fixture 108B can also be supplied to the first and second LEDs 412, 416 of any other LED modules 112 part of the string 1000, the string 1100, or any strings of LED modules 112. The first and second LEDs 412, 416 of these LED modules 112 will likewise emit light through the respective diffusers 400. For example, as illustrated by FIGS. 11A and 11B, the first connector assembly 800 of a first LED module 112A and the second connector assembly 900 of a second LED module 112B are mechanically and electrically connected as described herein. In particular, as best illustrated by FIG. 11B, the pivot stud 824 carried by the first end 510 of the first connector 500 of the first LED module 112A is disposed in the recess 552 and engages the pivot clip 920 of the first connector 500 of the second LED module 112B, thereby mechanically and electrically connecting the first end 510 of the first connector 500 of the first LED module 112 and the second end 520 of the first connector 500 of the second LED module 112. In that way, the first end 510 of the first connector 500 of the first LED module 112A is disposed in the recess 562 of the first connector 500 of the second LED module 112B, and the second end 520 of the first connector 500 of the second LED module 112B is disposed in the recess 552 of the first connector 500 of the first LED module 112A. Similarly, the pivot stud 924 carried by the first end 610 of the second connector 600 of the second LED module 112B is disposed in the recess 652 and engages the pivot clip 820 of the second connector 600 of the first LED module 112A, thereby mechanically and electrically connecting the second end 620 of the second connector 600 of the first LED module 112A and the first end 610 of the second connector 600 of the second LED module 112B. In that way, the first end 610 of the second connector 600 of the second LED module 112B is disposed in the recess 662 of the second connector 600 of the first LED module 112A, and the second end 620 of the second connector 600 of the first LED module 112A is disposed in the recess 652 of the second connector 600 of the second LED module 112B.

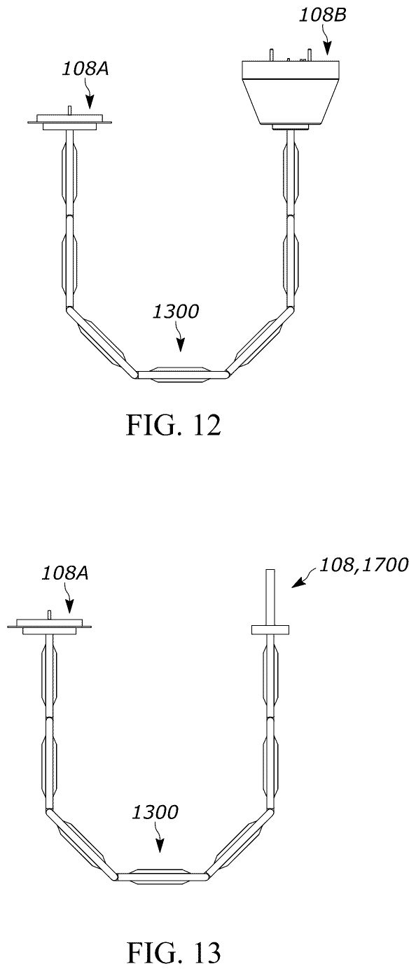

It will be appreciated that the lighting system 100 (and more particularly the first and second light fixtures 108A, 108B) can be customized by adjusting the components of the lighting system 100 in a number of different ways, as desired. Several examples are discussed below. First, by loosening the fasteners discussed above, the LED modules 112 can be rotated (up to 180 degrees) relative to the first light fixture 108A or the second light fixture 108B in order to, for example, adjust the direction or orientation of the LED modules 112. Second, one or more of the LED modules 112 can be removed from the string 1000, the string 1100, or another string in a similar manner (albeit the steps will be performed in reverse), which can be done in order to, for example, reduce the length of the string 1000, the string 1100, or other string. Third, additional LED modules 112 can be added to the string 1000, the string 1100, or other string in a similar manner in order to, for example, increase the length of the string 1000, the string 1100, or other string. Fourth, LED modules 112 coupled to one of the light fixtures 108 can be directly coupled to (or decoupled from) LED modules 112 coupled to another one of the light fixtures 108. As illustrated in, for example, FIG. 12, the LED modules 112 coupled to the first light fixture 108A can be directly coupled to the LED modules 112 coupled to the second light fixture 108B, thereby forming a swag 1300 of LED modules 112 that hang from and between the first light fixture 108A and the second light fixture 108B. As another example, the LED modules 112 coupled to the first light fixture 108A can be directly coupled to (or decoupled from) a third light fixture 108C in the form of a stand-off light fixture 1700 that is structurally similar to the light fixture 108A shown in FIG. 2 and installed in or on a desired surface in the environment 104, as illustrated in FIG. 13.

When, for example, it is desirable to directly couple the LED modules 112 coupled to the first light fixture 108A to the LED modules 112 coupled to the second light fixture 108B, it may be necessary for the recessed lighting system 100 to also include a hub connector 1500 that mechanically connects but electrically isolates the LED modules 112 coupled to the first light fixture 108A and the LED modules 112 coupled to the second light fixture 108B. More particularly, it may be necessary to include the hub connector 1500 in order to ensure that the recessed lighting system 100 maintains a specific class rating. For example, it may be necessary to include the hub connector 1500 in order to ensure that the recessed lighting system 100 maintains a class 2 rating, which limits each light fixture 108 to 100 W, i.e., a length of 20 feet.

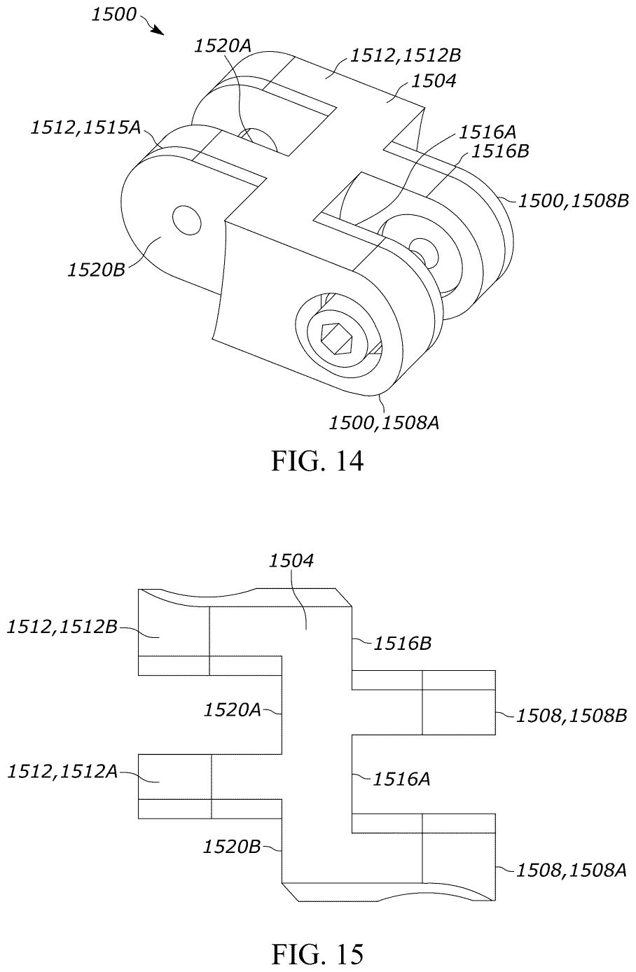

As illustrated in FIGS. 14 and 15, the hub connector 1500 in this example generally includes a base 1504, a first pair of connectors 1508 coupled to the base 1504, and a second pair of connectors 1512 coupled to the base 1504. The first pair of connectors 1508 extend outward from the base 1504 in a first direction, with a first connector 1508A extending outward along a first axis and a second connector 1508B extending outward along a second axis parallel to the first axis, such that the second connector 1508B is spaced from the first connector 1508A. In turn, the hub connector 1500 also includes a first pair of recesses-a first recess 1516A defined between the first and second connectors 1508A, 1508B, and a second recess 1516B defined by the base 1504 and the second connector 1508B. The second pair of connectors 1512 also extend outward from the base, but in a second direction opposite the first direction, with a first connector 1512A extending outward along a first axis and a second connector 1512B extending outward along a second axis parallel to the first axis, such that the second connector 1512B is spaced from the first connector 1512A. In turn, the hub connector 1500 also includes a second pair of recesses-a first recess 1520A defined between the first and second connectors 1512A, 1512B, and a second recess 1520B defined by the base 1504 and the second connector 1512B.

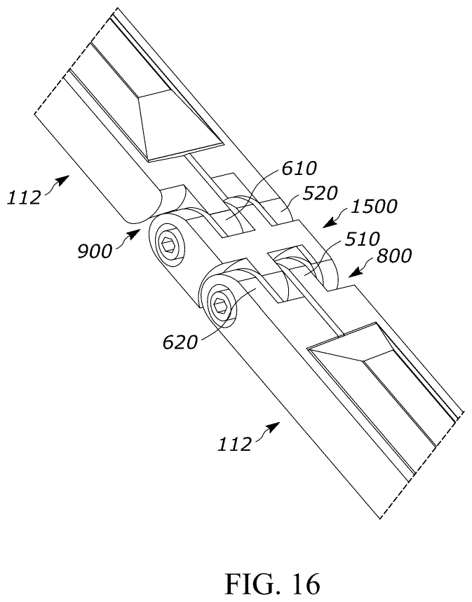

In order to form the swag 1300 using the hub connector 1500, the first pair of connectors 1508 is directly coupled to one of the LED modules 112 coupled to the first light fixture 108A and the second pair of connectors 1512 is directly coupled to one of the LED modules 112 coupled to the second light fixture 108B, as illustrated in FIG. 16. First, the hub connector 1500 is positioned between the two LED modules 112 (coupled to the different light fixtures 108A, 108b, respectively) to be mechanically connected to one another. Next, the connectors 500, 600 of one of the LED modules 112 are disposed in the recesses 1516A, 1516B, respectively, of the hub connector 1500, while the connectors 500, 600 of the other LED module 112 are disposed in the recesses 1520A, 1520B, respectively, of the hub connector 1500. At the same time, the connectors 1508A, 1508B are disposed in the recesses 552, 662, respectively, of the one LED module 112, and the connectors 1512A, 1512B are disposed in the recesses 562, 652, respectively of the other LED module 112. In turn, the connectors 500, 600 of both LED modules 112 and the connectors 508A, 508B, 512A, 512B of the hub connector 1500 can be removably secured in this position by inserting one or more fasteners therethrough, just as described above. In this manner, the hub connector 1500 is mechanically connected to both LED modules 112, and, therefore, serves to mechanically connect the LED modules 112 coupled to the first light fixture 108A and the LED modules 112 coupled to the second light fixture 108B. At the same time, while the hub connector 1500 is electrically connected to both LED modules 112, the structure of the hub connector 1500 serves to isolate the two electrical connections from one another, thereby electrically isolating the LED modules 112 coupled to the first light fixture 108A from the LED modules 112 coupled to the second light fixture 108B (and vice-versa). Accordingly, the one or more drivers of the junction box 158 of the first light fixture 108A can provide power to the first and second LEDs 412, 416 of the LED modules 112 coupled thereto, which in turn emit light, and the one or more drivers of the junction box of the second light fixture 108B can provide power to the first and second LEDs 412, 416 of the LED modules 112 coupled thereto, which likewise in turn emit light.

On the other hand, when it is desirable to directly couple the LED modules 112 coupled to the first light fixture 108 to the LED modules 112 coupled to the third light fixture 108C or another stand-off fixture, it is not necessary to employ the hub connector 1500 between the two different sets of LED modules 112. It will be appreciated that the hub connector 1500 is not necessary because the third light fixture 108C does not include any drivers (or other power source).

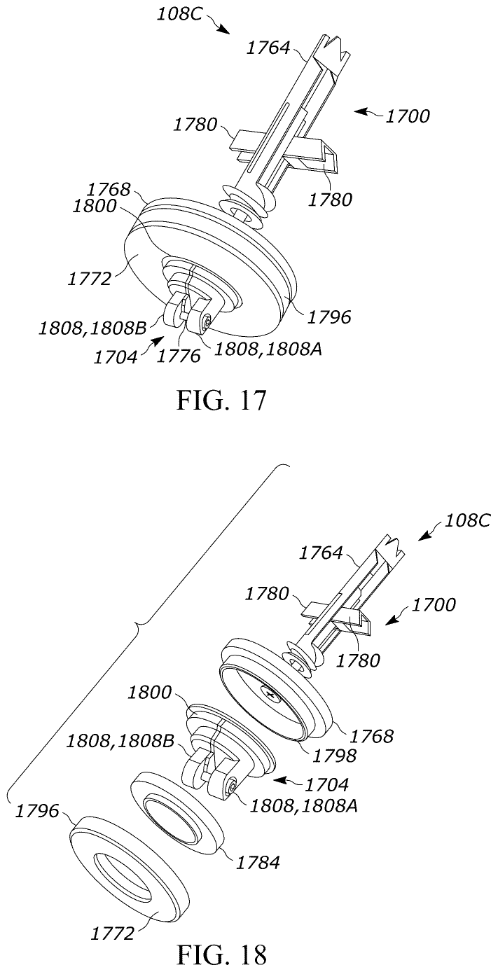

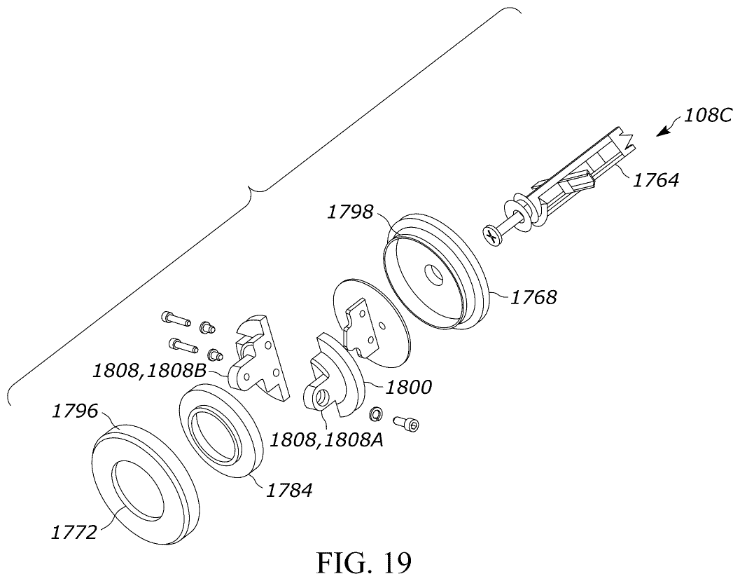

As illustrated in FIGS. 17-19, the third light fixture 108C generally includes a mounting assembly 1700 and a connection assembly 1704 removably coupled to the mounting assembly 1700. The connection assembly 1704 is structurally and functionally similar to the first canopy connection assembly 154 of the first light fixture 108A, in that the connection assembly 1704 includes a base 1800 (similar to the base 200) and a pair of connectors 1808 (similar to the connectors 208) coupled to the base 1800. Meanwhile, the mounting assembly 1700 is functionally similar to the first canopy assembly 150 of the first light fixture 108A, in that the mounting assembly 1700 is generally configured to be partially disposed in and engage the desired surface (e.g., the ceiling, floor, or other surface) in the environment 104 in order to retain the third light fixture 108C in position in or on the desired surface in the environment 104. However, the mounting assembly 1700 has a different structural arrangement than the first canopy assembly 150 of the first light fixture 108A.

In this example, the mounting assembly 1700 includes an anchor 1764, a collar 1768 coupled to the anchor 1764, and a ring 1772. In this example, the base 1800 is sized to be disposed within, and be surrounded by, the collar 1768, each of which has an annular shape. Moreover, in this example, the pair of connectors 1808 extend outward from the base 1800, with a first connector 1808A extending outward along a first axis and a second connector 1808B extending outward along a second axis parallel to the first axis, such that the second connector 1808B is spaced from the first connector 1808A. In turn, the mounting assembly 1700 also includes a recess 1776 defined between the first connector 1808A and the second connector 1808B. Like the recess 212 described above, the recess 1776 is sized to receive a portion of one of the LED modules 112 adjacent thereto in order to mechanically and electrically connect the third light fixture 108C to that LED module 112.

The anchor 1764, which in this example is a heavy duty drywall anchor, includes a pair of retractable arms 1780 that extend radially outward to secure the anchor 1764 (and the third light fixture 108C more generally) to the desired surface. The collar 1768, meanwhile, is coupled to one end of the anchor 1764 such that the collar 1768 is carried by and extends outward from the end of the anchor 1764. When the base 1800 is disposed within the collar 1768, the pair of connectors 1808 also extend outward from and of the collar 1768.

In this example, the mounting assembly 1700 can also include a washer 1784 that helps to secure the base 1800 within the collar 1768 and to position the pair of connectors 1808 properly. In this example, the washer 1784 has an annular shape and is seated against the base 1800 such that the washer 1784 is disposed outside of the collar 1768 and the pair of connectors 1808 extend outward from and of the washer 1784. As best illustrated in FIG. 17, the ring 1772 is removably coupled to the collar 1768 in order to securely retain the other components of the third light fixture 108C in place. In this example, the ring 1772 is removably coupled to the collar 1768 via a plurality of threads formed on an inner surface of a rim 1796 of the ring 1772 and configured to threadably engage a plurality of threads (not shown) formed on an outer surface 1798 of the collar 1768. In other examples, however, the ring 1772 can be coupled to the collar 1768 in a different manner and/or the ring 1772 can be coupled to a different component. In any event, when the ring 1772 is coupled to the collar 1768, the pair of connectors 1808 extend outward from and of the ring 1772, such that the pair of connectors 1808 are arranged to engage one of the LED modules 112 positioned adjacent thereto.

Because the system 100 is a constant voltage system, and because the connection assembly 1704 is configured to provide both a mechanical and electrical connection, the connection assembly 1704 has a positive side (with positive polarity) and a negative side (with negative polarity). Preferably, the positive side is isolated from the negative side (and vice versa) by the washer 1784. While not explicitly illustrated herein, the connection assembly 1704 in this example is approximately divided in half, with a first, positive half that is marked with a positive indicator (e.g., like the positive indicator 234), and a second, negative half. In this example, the first, positive half includes the first connector 1808A and the second, negative half includes the second connector 1808B. In other examples, however, the first half can have a negative polarity and the second half can have a positive polarity.

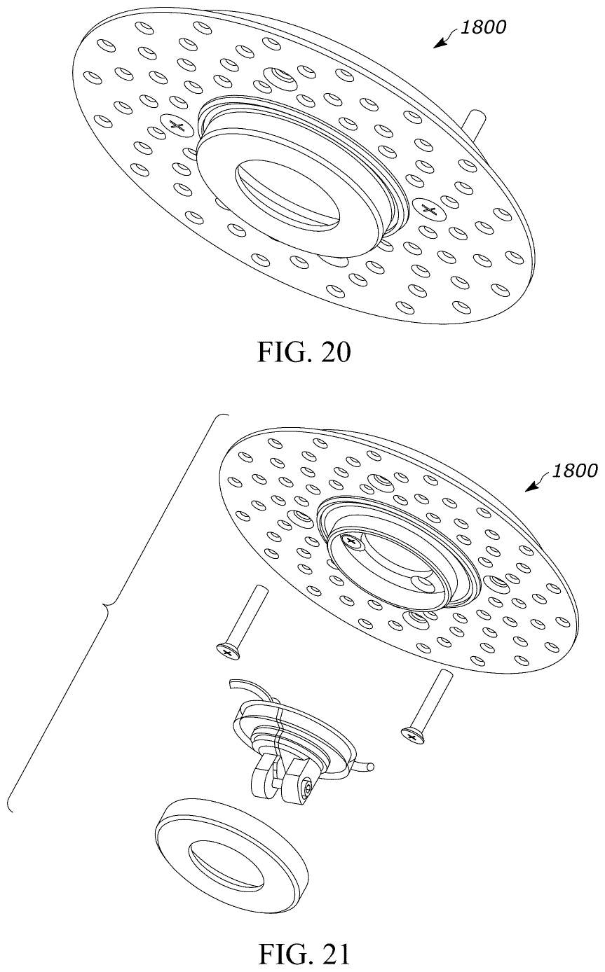

FIGS. 20 and 21 illustrate another example of a light fixture 1800 that is constructed in accordance with the principles of the present disclosure and can be employed in the modular, recessed lighting system 100 (instead of or in addition to the first, second, and third light fixtures 108A, 108B, 108C). The light fixture 1800 is substantially similar to the first light fixture 108A, with the exception that the light fixture 1800 is installed differently than the first light fixture 108A. Unlike the first light fixture 108A, the light fixture 1800 is configured to be mudded to the desired surface in the environment 104 such that the light fixture 1800 is fully recessed within and substantially flush with the desired surface. Thus, the light fixture 1800 need not include a cover plate such as the cover plate 170. The light fixture 1800 can thus be referred to herein as a flangeless light fixture (as opposed to the first light fixture 108A, which can be referred to herein as a flanged light fixture).

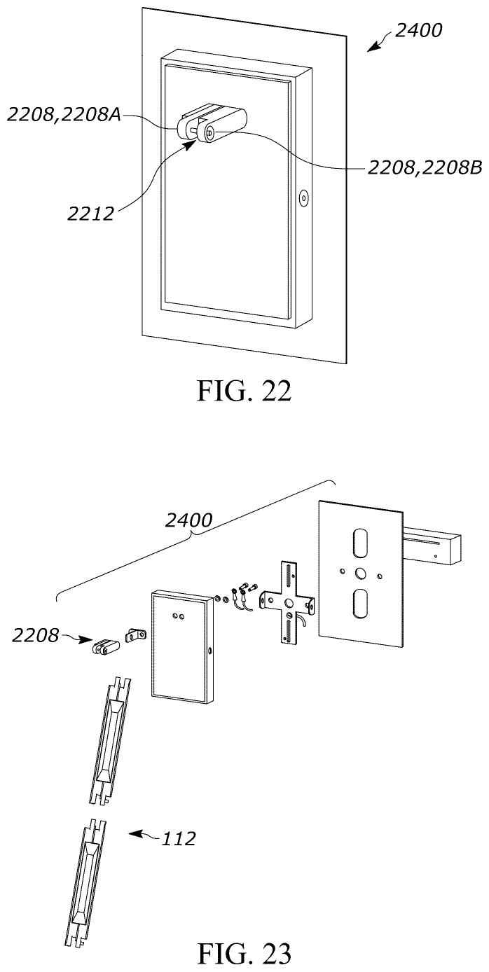

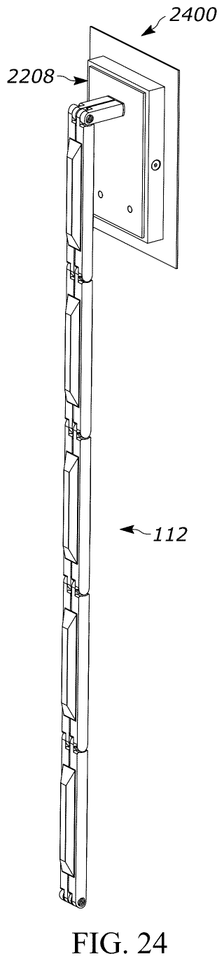

FIGS. 22-24 illustrate another example of a light fixture 2200 that is constructed in accordance with the principles of the present disclosure and can be employed in the modular, recessed lighting system 100 (instead of or in addition to the light fixtures 108A, 108B, 108C, and 1800), as well as a plurality of LED modules 112 coupled to one another and to the light fixture 2200 (with one of the LED modules 112 directly coupled thereto). The light fixture 2200 is similar to the other light fixtures 108A, 108B, 108C, and 1800, in that the light fixture 2200 includes a pair of connectors 2208 that extend outward, with a first connector 2208A extending outward along a first axis and a second connector 2208B extending outward along a second axis parallel to the first axis, such that the second connector 2208B also includes a recess 2212 defined between the first and second connectors 2208A, 2208B. Consistent with the discussion above, the recess 2212 is sized to receive a portion of an LED module 112 directly coupled to the light fixture 2200 in order to mechanically and electrically connect the LED module 112 to the light fixture 2200 (and vice-versa). However, unlike the other light fixtures 108A, 108B, 108C, and 1800, the light fixture 2200 is adapted to be installed such that the pair of connectors 2208 extend outward in a direction that is substantially perpendicular (if not entirely perpendicular) to the plurality of LED modules 112, as best illustrated in FIG. 24. More particularly, the first and second axes (along which the first and second connectors 2208A, 2208B respectively extend) are oriented substantially perpendicular (if not entirely perpendicular) to the plurality of LED modules 112. Further yet, while not illustrated herein, it will be appreciated that the light fixture 2200 includes a variable power supply that can be adjusted to increase or decrease the number of LED modules 112 that can be coupled to and powered by the light fixture 2200.

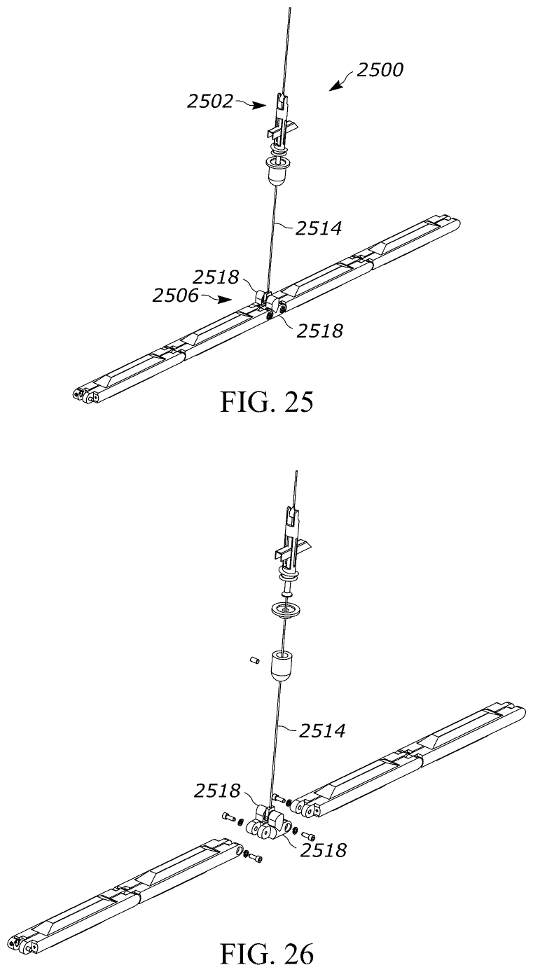

FIGS. 25 and 26 illustrate another example of a light fixture 2500 that is constructed in accordance with the principles of the present disclosure and can be employed in the modular, recessed lighting system 100 (instead of or in addition to the light fixtures 108A, 108B, 108C, 1800, and 2200). The light fixture 2500 is most similar to the third light fixture 108C, as the light fixture 2500 is also a stand-off fixture. Like the third light fixture 108C, the light fixture 2500 generally includes a mounting assembly 2502 and a connection assembly 2506 coupled to the mounting assembly 2502.

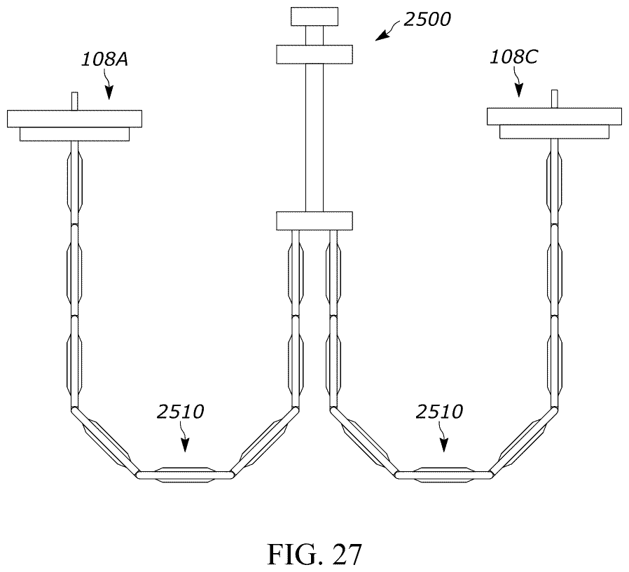

The mounting assembly 2502 is functionally identical to the connection assembly 1700 of the third light fixture 108C. However, the connection assembly 2506 is structurally and functionally different from the connection assembly 1704 of the third light fixture 108C. Generally speaking, the connection assembly 2506 is adapted to be coupled to two different strings 2510 of LED modules 112 so as to connect those two different strings 2510 of LED modules 112 together, as illustrated in FIG. 27. In particular, the connection assembly 2506 takes the form of a cable 2514 and two pairs of connectors 2518 coupled to the cable 2514. Each of the pairs of connectors 2518 is similar to, for example, the connectors 1808 discussed above, with a first pair of connectors 2518 extending outward in a first direction and adapted to be directly coupled to an LED module 112 of a first string 2510 of LED modules 112, and a second pair of connectors 2518 extending outward in a second direction and adapted to be directly coupled to an LED module 112 of a second string 2510 of LED modules 112. It will be appreciated that the cable 2514 can be adjusted (e.g., lengthened, shortened) in order to move the ends of the strings 2510 of LED modules 112 closer to or further from the mounting assembly 2502 (and, in turn, the desired surface to which the mounting assembly 2502 is installed).

Finally, it will be appreciated that the modular, recessed lighting system 100 can be customized to include other components that help to satisfy additional or different aesthetic and/or illuminative requirements than the components discussed herein. The modular, recessed lighting system 100 can, for example, include one or more stems that can be removably coupled between one of the light fixtures and one of the LED modules 112. In some cases, the modular, recessed lighting system 100 can include a plurality of differently sized stems (e.g., one or more stems having a length of 12 inches and one or more stems having a length of 6 inches). The one or more stems, which can be removably coupled to one another (e.g., via a threaded connection) as desired, can in turn move the LED module 112 directly coupled thereto (as well as any LED modules 112 coupled to that LED module 112) further away from the light fixture to which the LED module(s) 112 is/are coupled. FIG. 28 illustrates one such example, in which a stem 2800 is directly coupled to both the first light fixture 108A and directly coupled to the string 1000 of LED modules 112, such that the stem 2800 is disposed between the first light fixture 108A and the string 1000 of LED modules 112 and thereby moving the string 1000 of LED modules 112 further from the first light fixture 108A (and the desired surface to which the first light fixture 108A is installed). FIG. 29 illustrates another such example, in which a stem 2900 is directly coupled to both the second light fixture 108B and directly coupled to the string 1100 of LED modules 112, such that the stem 2900 is disposed between the second light fixture 108B and the string 1100 of LED modules 112 and thereby moving the string 1100 of LED modules 112 further from the second light fixture 108B (and the desired surface to which the second light fixture 108B is installed).

Finally, while each of the LED modules 112 has the ornamental design specifically illustrated in FIGS. 7A, 7B, 8, and 11A, it will be appreciated that other ornamental designs are possible.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A light-emitting diode (LED) module for use in a modular lighting system installed in an environment, the LED module configured to illuminate the environment and comprising:
a first connector;
a second connector coupled to and electrically isolated from the first connector;
a diffuser disposed between and coupled to the first connector and the second connector;
a first printed circuit board (PCB) disposed adjacent a first end of the diffuser;
a second PCB disposed adjacent a second end of the diffuser;
a first LED disposed on the first PCB and configured to emit light through the diffuser; and
a second LED disposed on the second PCB and configured to emit light through the diffuser.

2. The LED module of claim 1, further comprising:
a first connector assembly configured to mechanically connect a first end of the first connector to a second end of the second connector, the first connector assembly configured to electrically connect the first connector and the second connector to the first PCB while electrically isolating the second connector from the first connector; and
a second connector assembly configured to mechanically connect a second end of the first connector to a first end of the second connector, the second connector assembly configured to electrically connect the first and the second connector to the second PCB while electrically isolating the first connector from the second connector.

3. The LED module of claim 2, wherein the first connector assembly is further configured to mechanically and electrically connect the first end of the first connector to an end of a second LED module or a light fixture of the modular lighting system, and wherein the second connector assembly is further configured to mechanically and electrically connect the second end of the first connector to an end of the light fixture or a third LED module of the modular lighting system.

4. The LED module of claim 2, wherein the first connector assembly comprises:
a first pivot clip disposed within an opening formed in the second end of the second connector; and
a first pivot stud disposed within a first opening formed in the first end of the first connector and configured to be disposed within another opening formed in the end of the second LED module or the light fixture;
a first insulator bushing; and
a first insulator stud disposed within a second opening formed in the first end of the first connector,
wherein the first insulator stud extends through the first insulator bushing and engages the first connector and the second connector, and wherein the first insulator bushing is configured to electrically isolate the first connector from the second connector.

5. The LED module of claim 3, wherein the second connector assembly comprises:
a second pivot clip disposed within an opening formed in the second end of the first connector;
a second pivot stud disposed within a first opening formed in the first end of the second connector and configured to be disposed within another opening formed in the end of the third LED module or the light fixture;
a second insulator bushing; and
a second insulator stud disposed within a second opening formed in the first end of the second connector,
wherein the second insulator stud extends through the second insulator bushing and engages the first connector and the second connector, wherein the second insulator bushing is configured to electrically isolate the first connector from the second connector.

6. The LED module of claim 1, further comprising one or more first contact springs disposed adjacent to the first end of the diffuser and configured to mechanically and electrically connect the first PCB and the second PCB to the first connector.

7. The LED module of claim 6, wherein the one or more first contact springs are disposed in a channel formed by the first connector.

8. The LED module of claim 6, further comprising one or more second contact springs disposed adjacent to the second end of the diffuser and configured to mechanically and electrically connect the first PCB and the second PCB to the second connector.

9. The LED module of claim 1, wherein the first connector is electrically isolated from the second connector.

10. (canceled)

11. (canceled)

12. (canceled)

13. The LED module of claim 1, wherein the diffuser is removably coupled to the first connector and the second connector.

14. The LED module of claim 6, wherein one of the one or more first contact springs is mechanically and electrically connected to a negative end of the first PCB and the second connector.

15. The LED module of claim 6, wherein one of the one or more first contact springs is mechanically and electrically connected to a positive end of the first PCB and the first connector.

16. A modular lighting system adapted to be installed in an environment, the modular lighting system configured to illuminate the environment and comprising:
a first light-emitting diode (LED) module comprising a first connector, a second connector, a first diffuser disposed between and coupled to the first connector and the second connector, a first printed circuit board (PCB) disposed adjacent to a first end of the first diffuser, a first LED disposed on the first PCB and configured to emit light into the environment through the first diffuser, and a first connector assembly;
a second light-emitting diode (LED) module comprising a third connector, a fourth connector, a second diffuser disposed between and coupled to the third connector and the fourth connector, a second printed circuit board (PCB) disposed adjacent to the second diffuser, a second LED disposed on the second PCB and configured to emit light into the environment through the second diffuser, and a second connector assembly,
wherein the first connector assembly is configured to mechanically connect a first end of the first connector to a second end of the second connector, the first connector assembly configured to connect the first connector and the second connector to the first PCB while electrically isolating the second connector from the first connector, and
wherein the second connector assembly is configured to mechanically and electrically connect the second LED module to the first LED module via the first connector assembly.

17. A modular lighting system adapted to be installed in an environment, the modular lighting system configured to illuminate the environment and comprising:
a first light fixture comprising a first canopy assembly adapted to engage a desired surface in the environment;
a first light-emitting diode (LED) module comprising a first connector, a second connector, a first diffuser, a first LED disposed adjacent to the first diffuser and configured to emit light into the environment, a first connector assembly, and a second connector assembly;
a second light-emitting diode (LED) module comprising a third connector, a fourth connector, a second diffuser, a second LED disposed adjacent to the second diffuser and configured to emit light into the environment, a third connector assembly, and a fourth connector assembly,
wherein the first connector assembly is configured to mechanically and electrically connect the first LED module to the first light fixture via the first canopy assembly,
wherein the third connector assembly is configured to mechanically and electrically connect the second LED module to the first LED module via the second connector assembly, and
wherein the first LED module is interchangeable with a third LED module comprising a fifth connector assembly and a sixth connector assembly configured to mechanically and electrically connect the third LED module to both the second LED module via the third connector assembly and the first light fixture via the first canopy assembly.

18. The modular lighting system of claim 17, further comprising:
a second light fixture comprising a second canopy assembly adapted to engage a second desired surface in the environment;
a plurality of light-emitting diode (LED) modules mechanically and electrically connected to the first canopy assembly and/or the second canopy assembly, wherein the plurality of LED modules comprises:
the first LED module; and
the second (LED) LED module,
wherein the fourth connector assembly is configured to mechanically and electrically connect the second LED module to the second light fixture via the second canopy assembly.

19. The modular lighting system of claim 16,
wherein the first LED module includes a third PCB disposed adjacent a second end of the first diffuser and a third LED disposed on the third PCB and configured to emit light into the environment through the first diffuser,
wherein the first connector assembly is configured to mechanically connect a first end of the first connector to a second end of the second connector, the first connector assembly configured to electrically connect the first connector and the second connector to the first PCB while electrically isolating the second connector from the first connector, and
wherein the second connector assembly is configured to mechanically connect a second end of the first connector to a first end of the second connector, the second connector assembly configured to electrically connect the first and the second connector to the third PCB while electrically isolating the first connector from the second connector.

20. (canceled)

21. The modular lighting system of claim 19, wherein the first connector assembly comprises:
a first pivot clip disposed within an opening formed in the second end of the second connector; and
a first pivot stud disposed within a first opening formed in the first end of the first connector and configured to be disposed within another opening formed in the end of the another LED module or the light fixture;
a first insulator bushing; and
a first insulator stud disposed within a second opening formed in the first end of the first connector,
wherein the first insulator stud extends through the first insulator bushing and engages the first connector and the second connector, and wherein the first insulator bushing is configured to electrically isolate the first connector from the second connector.

22. The modular lighting system of claim 21, wherein the second connector assembly comprises:
a second pivot clip disposed within an opening formed in the second end of the first connector;
a second pivot stud disposed within a first opening formed in the first end of the second connector and configured to be disposed within another opening formed in the end of the another LED module or the light fixture;
a second insulator bushing; and
a second insulator stud disposed within a second opening formed in the first end of the second connector,
wherein the second insulator stud extends through the second insulator bushing and engages the first connector and the second connector, wherein the second insulator bushing is configured to electrically isolate the first connector from the second connector.

23. The modular lighting system of claim 19, wherein the first LED module further comprises one or more first contact springs disposed adjacent to the first end of the diffuser and configured to mechanically and electrically connect the first PCB and the third PCB to the first connector.

24. The modular lighting system of claim 23, wherein the one or more first contact springs are disposed in a channel formed by the first connector.

25. The modular lighting system of claim 23, wherein the first LED module further comprises one or more second contact springs disposed adjacent to the second end of the diffuser and configured to mechanically and electrically connect the first PCB and the second PCB to the second connector.

26. The modular lighting system of claim 16, wherein the first connector is electrically isolated from the second connector.

27. (canceled)

28. (canceled)

29. (canceled)

30. The modular lighting system of claim 16, wherein the first diffuser is removably coupled to the first connector and the second connector.

31. The modular lighting system of claim 23, wherein one of the one or more first contact springs is mechanically and electrically connected to a negative end of the first PCB and the second connector.

32. The modular lighting system of claim 23, wherein one of the one or more first contact springs is mechanically and electrically connected to a positive end of the first PCB and the first connector.
